(19) United States
(12) Patent Application Publication
(10) Pub. No.: US 2014/0162093 A1
(43) Pub. Date: Jun. 12, 2014

(54) ENERGY STORAGE DEVICE HAVING A SAFETY COATING

(71) Applicants: Samsung SDI Co., Ltd., Yongin-si (KR); Robert Bosch GmbH, Stuttgart (DE)

(72) Inventors: Alexander Reitzle, Neu-Ulm (DE); Markus Kohlberger, Stuttgart (DE)

(73) Assignees: Samsung SDI Co., Ltd., Yongin-si (KR); Robert Bosch GmbH, Stuttgart (DE)

(21) Appl. No.: 14/103,174

(22) Filed: Dec. 11, 2013

(30) Foreign Application Priority Data
Dec. 12, 2012 (DE) 10 2012 222 876.4

(51) Int. Cl. H01M 10/659

(52) U.S. Cl. CPC H01M 10/5089
USPC 429/62

(57) ABSTRACT

An electrochemical energy storage device includes a cell space for at least partially accommodating an anode and a cathode. The cell space is separated at least partially from the external surroundings by a housing. The energy storage device at least partially includes a coating configured to foam by the action of heat.

This application claims priority under 35 U.S.C. §119 to patent application no. DE 10 2012 222 876.4 filed on Dec. 12, 2012 in Germany, the disclosure of which is incorporated herein by reference in its entirety.

### BACKGROUND

The present disclosure relates to an energy storage device. The present disclosure relates, in particular, to an energy storage device having a safety coating to prevent or reduce thermally induced damage.

Energy storage devices, such as lithium-ion batteries, are widely used in many daily applications. For example, they are used in computers, e.g. laptops, mobile telephones, smartphones and other applications. Such batteries also offer advantages in the electrification of vehicles, such as motor vehicles, which is currently well advanced.

Various possibilities are known for reducing a risk stemming from an energy storage device, such as a lithium-ion battery. These are intended, in particular, to reduce the risk that the energy storage device will overheat or burn, in an accident for example. Overall, appropriate safety measures can make the use of energy storage devices possible without significant risks to people and the environment.

It is possible, for example, to provide systems which keep the temperature prevailing in the energy storage device below a predetermined value in order in this way to reduce damage due to excess heating.

### SUMMARY

The subject matter of the present disclosure is an electrochemical energy storage device comprising at least one cell space for at least partially accommodating an anode and a cathode, wherein the at least one cell space is separated at least partially from the external surroundings by at least one housing, and wherein the energy storage device is provided at least partially with a coating, wherein the coating can be made to foam by the action of heat.

In the sense intended by the present disclosure an electrochemical energy storage device can be, in particular, any battery. In particular, an energy storage device can be not only a primary battery but also especially a secondary battery, i.e. a rechargeable accumulator. In this context, a battery can be a single galvanic element or a plurality of interconnected galvanic elements. For example, an energy storage device can comprise a lithium-based energy storage device, such as a lithium-ion battery. Here, a lithium-based energy storage device, such as a lithium-ion battery, can be understood to mean, in particular, an energy storage device, the electrochemical processes of which during a charge or discharge process are based at least partially on lithium ions.

In the sense intended by the present disclosure, a cell space can furthermore be understood to mean, in particular, a space in which the anode, the cathode, a separator arranged between the anode and the cathode, and an electrolyte are present or are arranged. Thus, the cell space is, in particular, a space of the kind in which the electrochemical processes occurring for a charge or discharge process of the energy storage device take place at least in part. It is possible both for a housing at least partially delimiting the cell space to delimit the cell space directly, that is to say, purely by way of example, to be configured as the wall of the cell space, and for a further housing at least partially delimiting the cell space to indirectly delimit the cell space. In the latter case, the housing can be configured, for example, as a further housing surrounding a housing directly delimiting the cell space and hence as a housing delimiting a cell stack, for example.

The anode and the cathode can fundamentally be configured in a manner known per se, as known for an energy storage device. For the purely illustrative case of a lithium-ion battery, the anode can be an electrode which comprises metallic lithium or can intercalate lithium. Here, the cathode can contain NMC or lithium cobalt oxide (LiCoO₂), for example. In this case, the cathode material may be present in a binder, such as polyvinylidene fluoride (PVDF), possibly together with a conductive additive, such as an electrically conductive carbon compound, e.g. graphite. The electrolytes can comprise a solvent in which one or more electrically conductive salts are dissolved. For example, aprotic solvents, e.g. ethylene carbonate, propylene carbonate, dimethyl carbonate or diethyl carbonate, can be used. Lithium hexafluorophosphate (LiPF₆) can furthermore be used as an electrically conductive salt.

A separator is furthermore arranged in a manner known per se between the anode and the cathode to separate the anode and the cathode spatially from one another, in particular to prevent a short circuit. In this case, the separator can, for example, comprise or be formed from plastic films, in particular porous plastic films, fiberglass cloth or, alternatively, ceramic materials, especially porous ceramic materials, such as ceramic cloths. In this case, the electrolyte can be arranged within the separator or within pores of the separator, for example.

The external surroundings can furthermore be the atmosphere surrounding the energy storage device, for example, that is to say, in particular, the air surrounding the energy storage device or components adjoining the energy storage device or the atmosphere in a cell stack.

In the sense intended by the present disclosure, the action of heat can furthermore be understood to mean the action of such a temperature, which temperature is above the normal operating temperature of the energy storage device. In particular, the action of heat can be understood to mean the action of a temperature which may bring about a state critical for safety or which is caused by an operating state which is critical for safety, for example.

An electrochemical energy storage device described above makes it possible to enable particularly safe operation thereof in a low-cost manner and thus makes it possible significantly to reduce potential risk for an operator or for the surroundings or environment of the energy storage device.

An energy storage device of this kind can be, for example, a lithium-based energy storage device, such as a lithium-ion battery, and, in particular, comprises at least one cell space, in which an anode and a cathode are at least partially arranged. Arranged between the anode and the cathode are a separator and an electrolyte to enable the energy storage device to work in a manner known per se. The at least one cell space is separated at least partially, in particular completely, from the external surroundings by a housing. Thus, the cell space is, in particular, a gas tight volume, advantageously a completely gas tight volume, from which substances such as, in particular, gases or other cell components that can form, for example, during a charge process, during a discharge process or even during a malfunction are prevented from escaping.

In the case of an energy storage device described above, the energy storage device is furthermore provided at least partially with a coating, wherein the coating can be made to foam by the action of heat or the action of heat triggers foaming of the coating. This behavior of the coating is referred to as intumescence. One trade name of a known substance which has such behavior is Fomox from Bayer, for example. It is thus possible, in the case of an energy storage device described above, for an effective and efficient thermal insulating layer to form immediately in response to the action of heat.

By way of example, shaped parts between the individual cells and other components can be coated with or composed of the intumescence material. This is advantageous, for example, in the case of air cooled systems with plastic separating parts, which can have the coating. Sheathing of cables can also be appropriate, and the examples described above are not restrictive.

In detail, the fact that a coating which can be made to foam by the action of heat is provided allows rapid and effective formation of a layer which, by virtue of the fact that it comprises a foam, has a particularly good thermal insulating capacity. As a result, a fault of the energy storage device associated with the development of a large amount of heat can be mitigated, thus significantly reducing the negative effects on the energy storage device itself and on its surroundings and hence equally the potential risk for an operator.

At the same time, the fact that the insulating layer, namely the foam which forms from the coating, comes into being only in response to the development of an inordinately large amount of heat and is not present during normal operation of the energy storage device means that there is no negative effect on a normal operating state. Thus the installation space within and/or outside a cell, in particular, can remain unaffected, and this can have advantages in respect to production since it is essentially possible to use conventional components.

Another advantage of a foamable coating can be regarded as the fact that the free space or openings which form in plastic parts, e.g. the plastic cover of the module or the seals leading to the common degasification ducts, which have become soft or have melted due to the increase in temperature are filled. The module thus maintains its integrity. It is thus possible to prevent additional short circuits and an escape of gases besides the ducts provided for this purpose.

Moreover, the energy storage device can be produced in a particularly low cost manner since a single coating can be sufficient in relation to conventional energy storage devices, often entailing only a limited increase in costs.

In the case of an electrochemical energy storage device described above, the foamable coating furthermore has the advantage that it represents a purely passive safety feature and thus, once provided in an energy storage device, does not require activation, e.g. electronic activation, but automatically provides improved safety as soon as a malfunction occurs. A foamable coating of this kind can thus be provided as a redundant feature or supplement to active monitoring of the energy storage device, or of the cell space, by a battery management system (BMS).

Here, the battery management system can additionally be provided in combination with a cooling system, for instance, in order to keep a temperature below a predetermined value. For example, the battery management system can keep a temperature in a range of less than or equal to 60° by cooling, and can furthermore keep a temperature gradient as low as possible. In normal operation, these measures are enough to protect an energy storage device and an operator from faults or damage. At the same time, safety can be further enhanced by the foamable coating.

From what has been stated above and also from the following developments of an energy storage device described above, it will be seen that simple or combined functions can delay, reduce or completely prevent negative effects of a faulty operating state on people, the environment or the system in which the energy storage device is arranged.

In the context of one embodiment, at least one housing can be provided at least partially with the coating. In this way, the cell which has a malfunction or in which a greatly increased temperature occurs can be thermally decoupled or encapsulated in a simple manner from the external surroundings, for example. Thus, for example, it is possible effectively to prevent a large amount of liberated heat that may occur in a galvanic cell of the energy storage device due to a malfunction or misuse from being transferred to adjacent cells or to the surroundings of the energy storage device and thus setting in train a chain reaction. On the contrary, a potential fault can be locally limited to a cell or a cell stack, thereby making it possible, on the one hand, to significantly enhance safety while, on the other hand, damage to other cells or components can also be prevented or at least reduced. It is thus possible, especially in the case of a thermal event in one or more cells of the energy storage device, to limit the effects to adjacent elements by means of a thermal insulation produced in response to the liberation of heat.

In the context of another embodiment, the coating can be designed in such a way that it foams at a temperature in a range of from greater than or equal to 80° C. to less than or equal to 120° C., in particular at 100° C., i.e. foaming is triggered or begins in the abovementioned temperature range. In this embodiment, it is possible to ensure that no foam forms at a slightly increased temperature or at a temperature which corresponds to a normal operating state and that the coating thus remains stable if a faulty operating state does not occur. On the other hand, foaming can be triggered and a thermal insulation provided as a result when the temperature is still of a magnitude such that more severe damage can still be prevented. Particularly safe operation and, at the same time, reliable operation of the energy storage device can thus be achieved in this embodiment.

In the context of another embodiment, at least one housing provided with a coating that can be made to foam by the action of heat can directly surround a cell wall and hence can directly surround a galvanic element, at least partially, in particular completely. In this embodiment, the cell wall is thus provided as such at least partially with the foamable coating. In this embodiment, it is possible particularly to ensure that each individual cell or each galvanic element as such can be thermally decoupled from other cells of the energy storage device, when there is a battery stack for instance. It is thus possible in this embodiment not only to protect the atmosphere surrounding the energy storage device as a whole but also to protect a multiplicity of cells within the energy storage device. As a result, a fault can, if applicable, remain localized to individual cells, thereby minimizing any requirement for repair arising after a fault.

In the context of another embodiment, at least one housing provided with a coating that can be made to foam by the action of heat can at least partially, in particular completely, surround a cell stack. In this embodiment, it is thus possible, in addition or as an alternative to a cell wall, for a housing of this kind at least partially, in particular completely, surrounding a multiplicity of battery cells and hence a cell stack to be provided at least partially with a foamable coating. In this embodiment, it is possible, in particular, to prevent heat developed by the energy storage device from being transferred to components adjoining the energy storage device or to the atmosphere surrounding the energy storage device. In this embodiment, transfer of the heat developed from a cell stack or from an energy storage device to adjacent components, for example, can be prevented in a particularly effective manner by means of thermal decoupling. This allows particularly reliable operation of the energy storage device.

In the context of another embodiment, the outside of at least one housing can be provided at least partially, in particular completely, with the coating. In this embodiment, it is thus possible, for example, to use a conventional cell space or a conventional cell space housing, in particular with respect to the interior thereof, to produce the energy storage device. All that is required is the application of a foamable coating to the outer wall to enable the energy storage device in this embodiment to be produced. In this embodiment, it is thus possible to produce the energy storage device at particularly low cost and furthermore to adapt the coating to the respective energy storage device used through a modular construction, which is possible. In addition to particularly simple and low-cost production of an energy storage device, this furthermore enables particularly effective action by the coating and, as a result, particularly safe operation of the energy storage device. Moreover, there is a particularly free choice of coating material since there is no need to consider a potential interaction with the interior of the cell or with components in the interior of the cell if the housing directly adjoins a cell. In this embodiment, the foam formed can furthermore also serve as a spacer for components.

In the context of another embodiment, the inside of at least one housing is provided at least partially, in particular completely, with the coating. In this embodiment, it is possible to achieve the further advantage that triggering a foam formation can take place immediately in the case of a defined increased temperature. This is because the coating can be activated directly by the heat arising in the interior of the cell space or cell stack and is not separated from the interior of the cell or the interior of the cell stack by a housing providing—if only slight—thermal insulation. Moreover, the exterior of the cell space or of the housing can be of conventional design, and therefore no restrictions have to be imposed in respect of the fastening of a plurality of cells to one another, for example, or in respect of modifications to the design of the outside of the housing. In this embodiment too, however, the installation space within the cell can remain substantially unchanged since the foam is formed only in the case of a fault and the coating does not occupy any significant space.

In the context of another embodiment, the coating can have a fire retardant substance or a fire extinguishing substance. In this embodiment, it is not only possible to prevent the spread of the effects of heat in an effective manner but also equally to prevent the spread of fires or the ignition of the cell operating in the faulty state and of adjacent cells or of the surroundings of the energy storage device. It is thereby possible further to reduce the risk arising from the interior of the cell space. In this case, the fire retardant or fire extinguishing substance can be carbon dioxide released during foaming, for example, or it can be a substance of the kind known from a powder fire extinguisher, such as finely ground ammonium phosphate and ammonium sulfate, which is incorporated into the coating.

In the context of another embodiment, the coating can comprise a foamable finish. A finish as a coating material, in particular, can be applied particularly thinly and, at the same time, so as to cover the housing completely, thus ensuring that the coating per se is reliably applied but does not interfere with the normal operation of the energy storage device. In addition, finishes can be substantially safe from damage, thus ensuring that the coating is not destroyed or cannot be lost, even after a prolonged period of operation or when applied to the exterior of the housing. Moreover, finishes, in particular, can be matched particularly well to the desired area of application and can furthermore be applied by simple and known methods, with the result that production of the energy storage device in this embodiment can furthermore be at particularly low cost.

In the context of another embodiment, the foamable finish is based on an epoxy. A 2-component epoxy finish can be used, for example. For epoxy-based systems, in particular, effective foamable coatings, which can furthermore have low densities, can be possible. As a result, it is possible, in particular, in this embodiment, though not in a restrictive sense, to design an energy storage device according to the disclosure without a significant increase in weight, something that can be advantageous for mobile applications, in particular. Here, epoxy-based systems referred to as “epoxy PFP intumescent coatings” are known per se and, in principle, can be used in accordance with the disclosure.

### BRIEF DESCRIPTION OF THE DRAWINGS

Further advantages and advantageous embodiments of the subject matter according to the disclosure are illustrated by the examples and drawings and are explained in the following description. It should be noted here that the examples and drawings have only a descriptive character and are not intended to restrict the disclosure in any way. In the drawings:

FIG. 1 shows a schematic representation of one embodiment of an energy storage device according to the disclosure in a normal operating state; and

FIG. 2 shows a schematic representation of the embodiment according to FIG. 1 when a large amount of heat is developed.

### DETAILED DESCRIPTION

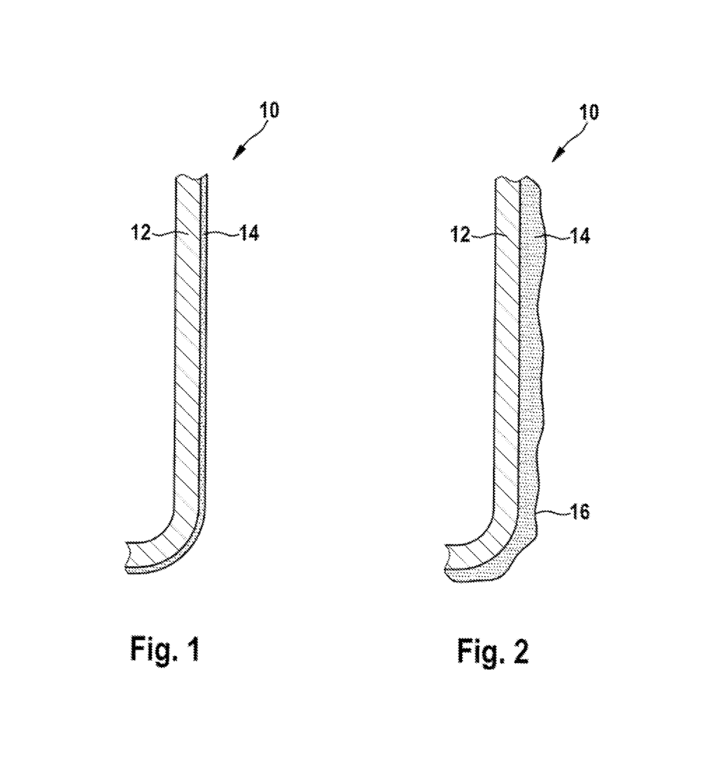

FIG. 1 shows a schematic representation of a partial area of an energy storage device 10 according to the present disclosure. In principle, an energy storage device 10 of this kind can be any type of energy storage device 10, in particular a battery, such as a rechargeable accumulator. The energy storage device 10 can be a lithium-ion accumulator, for example. Possible areas of application here comprise electrically driven vehicles, computers, e.g. laptops, mobile telephones, smartphones, electric tools and other applications, e.g. fully electrically driven vehicles (EV) or partially electrically driven vehicles (hybrid vehicles, PHEV).

In detail, FIG. 1 shows part of a housing 12. The housing 12 can separate a cell space for at least partially accommodating an anode and a cathode at least partially from the external surroundings. The housing 12 can be a cell wall directly surrounding a cell or a galvanic element, for example, or alternatively a housing 12 surrounding a battery stack, which battery stack can have a multiplicity of cells or galvanic elements.

FIG. 1 furthermore shows that the housing 12 is provided at least partially with a coating 14, wherein the coating 14 can be made to foam by the action of heat, e.g. at a temperature in a range of from greater than or equal to 80° C. to less than or equal to 120° C. According to FIG. 1, the outside of the housing 12 is provided at least partially with the coating 14. In addition or as an alternative, provision can be made for the inside of the housing 12 to be provided at least partially with the coating 14. Moreover, the coating 14 can have a fire retardant substance or a fire extinguishing substance.

In one illustrative embodiment, the coating 14 can furthermore be a foamable finish, which can be based on an epoxy, for example. In particular, the finish can be a 2-component epoxy finish, which can have a flame retardant for instance, e.g. a phosphoric ester.

Here, FIG. 1 shows a normal or intended operating state of the energy storage device 10, in which the coating is in the form of a low-volume coating, e.g. in a thickness in a range of from greater than or equal to 50 μm to less than or equal to 0.75 mm.

FIG. 2 furthermore shows the energy storage device 10 during or after the action of excessive heat or at a temperature which is above the normal operating temperature and excites foaming of the coating 14 or the coating material. In FIG. 2, it can be seen that the coating 14 has undergone an increase in volume due to the foaming and can now have a thickness in a range of from greater than or equal to 150 μm to less than or equal to 7.5 mm, for example. By virtue of the fact that the coating 14 has foamed and now has a sponge-like structure with a large number of gas inclusions, the coating 14 forms an effective crust-like thermal and electric insulating layer 16 owing to the foaming. For example, a heat transfer from a nonrestrictive value of 0.2 W/mK for the coating can be reduced by a factor of 10 for the illustrative case where an epoxy finish is used as a coating.

What is claimed is:

1. An electrochemical energy storage device, comprising:
at least one cell space configured to at least partially accommodate an anode and a cathode, the cell space being separated at least partially from the external surroundings by at least one housing,
wherein the energy storage device at least partially includes a coating configured to foam by the action of heat.

2. The energy storage device according to claim 1, wherein at least one housing is configured at least partially with the coating.

3. The energy storage device according to claim 1, wherein the coating is configured such that it foams at a temperature in a range of from greater than or equal to 80° C. to less than or equal to 120° C.

4. The energy storage device according to claim 2, wherein at least one housing provided with the coating that is configured to foam by the action of heat directly and partially surrounds a cell space.

5. The energy storage device according to claim 2, wherein at least one housing provided with a coating that is configured to foam by the action of heat at least partially surrounds a cell stack.

6. The energy storage device according to claim 2, wherein the outside of at least one housing is configured at least partially with the coating.

7. The energy storage device according to claim 2, wherein the inside of at least one housing is configured at least partially with the coating.

8. The energy storage device according to claim 1, wherein the coating includes a fire retardant substance or a fire extinguishing substance.

9. The energy storage device according to claim 1, wherein the coating comprises a foamable finish.

10. The energy storage device according to claim 9, wherein the foamable finish is based on an epoxy.

11. The energy storage device according to claim 4, wherein the at least one housing directly surrounds the cell space.
